(19) United States
(12) Patent Application Publication
(10) Pub. No.: US 2026/0278632 A1
(43) Pub. Date: Sep. 17, 2026

(54) VERSATILE LAYER-3 BLOCKCHAIN SERVICE INTERFACE FOR AUTOMATING AND DECENTRALIZING PECUNIARY MICRO TRANSACTIONS AMONG IOT AND M2M DEVICES

(71) Applicant: Theodore R. Schwartz, Stow, MA (US)

(72) Inventor: Theodore R. Schwartz, Stow, MA (US)

(21) Appl. No.: 19/242,238

(22) Filed: Jun. 18, 2025

Related U.S. Application Data
(60) Provisional application No. 63/770,624, filed on Mar. 12, 2025.

(51) Int. Cl. G06Q 30/0201; G06Q 20/40; H04L 9/00; H04L 9/32

(52) U.S. Cl. CPC G06Q 30/0206; G06Q 20/401; H04L 9/3247; H04L 9/50; G06Q 2220/00

(57) ABSTRACT

A device-facing Layer-3 blockchain service interface, installable within a broader electronic digital network, is engineered to adjust, hybridize, and couple Layer-1 and Layer-2 blockchain technologies that concurrently operate within, thereby offering e enabling advanced, automated, and cost-effective pecuniary transactions among enrolled, subscribed, and/or otherwise participating IoT and M2M devices. The Layer-3 blockchain service interface unlocks broad opportunities for automated micropayments, enabling practical, stable, scalable, and cost-effective solutions for smart devices in IoT and M2M networks. The service interface in particular utilizes a real-time market-based service registry for dynamic price and fee determination while facilitating decentralized authentication. Versatility, enhanced security, and the enablement of new revenue streams in IoT and M2M industries requiring real-time, trustless financial interactions are among the advantages of the service interface.

### CROSS REFERENCE TO RELATED APPLICATION

This application claims the benefit of Provisional U.S. Pat. App. Ser. No. 63/770,624 filed by Theodore R. Schwartz on Wednesday, Mar. 12, 2025.

### FIELD

The present invention relates to IoT and M2M network transaction processing technologies, and in particular, to a Layer-3 blockchain service interface for enabling hardware-based authentication, decentralized service execution, and real-time micropayment adjustment.

### BACKGROUND

Increasing functionality has been a consistent trend throughout the evolution of machines, from the early combination and mechanization of simple primitive tools to the modern computerization of complex machine functions. Once a unique selling feature for many machines, it is now increasingly difficult to find any machine that does not contain a control chip, a processor, or other electronic logic that tracks, senses, regulates, controls, or directs at least some of a machine's operation.

Currently—and of particular interest to the present invention—is the ongoing and rapid development of embedded electronic communication capabilities in otherwise functionally independent machines. Enabled as such, machines are now capable of “talking” to each to better cooperate and collaborate without substantial human intervention.

Machine-to-Machine (M2M) technology initially enabled electronic devices to communicate directly via wireless interfaces such as RFID, Bluetooth, and Wi-Fi. While effective for point-to-point exchanges, M2M systems are typically limited in scope and lack seamless internet integration.

The advent of the Internet of Things (IoT) technology expanded upon M2M technology by incorporating internet-based protocols, creating large-scale networks of interconnected “smart” devices capable of sensing, sharing, and collaborating autonomously. Unlike M2M, which relied on specialized, often proprietary connections, IoT technology employs standardized protocols (e.g., TCP/IP) to facilitate cloud integration, extensive data analytics, and remote accessibility. This evolution significantly broadened applications for automated device interactions, spanning industrial supply chains, RFID systems, smart homes, and autonomous vehicles. However, it also introduced challenges related to transaction scalability, security, and cost efficiency.

Whether operating within an IoT or M2M network, these connected devices—referred to herein as “networked smart devices”, “smart devices”, or “device nodes”—are designed to communicate and collaborate. This was and continues to be a welcomed development. However, it is foreseen that economic factors may increasingly hinder the scale and quality of inter-device interactions.

While automated, fee-based machine transactions are well-established (e.g., electronic toll collection), these transactions are characteristically high-value and predictable, and thus justifiably served using conventional financial technologies compliant with established and entrenched credit and debit card standards. In contrast, as IoT and M2M networks expand, the frequency of lower-value, less predictable transactions is expected to rise. The patterns of the past are shifting. The cost-benefit models that once adequately governed M2M and IoT transactions at comparatively small scale are foreseeably becoming obsolete as smart devices proliferate, expand, and increasingly engage in decentralized, automated, and lower-value micro transactions.

Regardless, sensing the changing tides, the present invention posits that so-called blockchain technology—which currently provides a popular, flexible, and less costly means for effecting decentralized online electronic payments—could be used to address the unique and divergent pecuniary and transactional needs of IoT and M2M networks. But this is neither easy nor straightforward. Focused throughout its evolution on industries with more customer-driven, less congested, and higher-value transactional traffic (e.g., “online retail” and “ecommerce”), blockchain technology standing alone is currently ill-fitted to serve the needs of IoT and M2M networks.

By way of background: A blockchain is a continuously growing ledger of cryptographically linked records, or “blocks,” each containing a hash of the previous block, a timestamp, and transaction data. Designed to resist modification, altering a recorded block requires changing all subsequent blocks and securing network-wide consensus—an impractical task in well-secured decentralized networks. Many blockchain systems maintain integrity by distributing full copies of the ledger to network nodes, while others store only a subset. Transactions are validated collectively through consensus mechanisms, eliminating single points of failure and enhancing security and trust.

A growing number of Layer-1 (L1) blockchain networks, such as Ethereum, Binance Smart Chain, and Solana, extend beyond simple transaction processing by supporting smart contracts (i.e., self-executing programs embedded the blockchain). These smart contracts automate conditions, actions, and outcomes without intermediaries, enabling a wide range of decentralized applications (dApps), decentralized finance (DeFi) platforms, and non-fungible tokens (NFTs). Among L1 networks, Ethereum is the most widely used, with ETH ($ETH) serving as its native cryptocurrency for transactions, gas fees, and staking.

While L1 blockchains provide a secure foundation for digital transactions, their rapid adoption has led to scalability challenges, the consequences of which are widely felt and widely reported in traditional economies. In the expanding IoT/M2M economy, it is projected that L1-scalability issues will be even more pronounced. IoT and M2M ecosystems rely on frequent, low-value transactions, making the cost and latency of direct L1 settlements impractical. These networks require a more efficient solution for processing high-frequency micropayments while maintaining security and decentralization.

To address L1 scalability issues, Layer-2 (L2) solutions—e.g., rollups (“Optimism”, “Arbitrum”, “zk-Rollups”), sidechains, and state channels—offload transaction processing from the main blockchain. These technologies aggregate multiple transactions off-chain or in batches before committing them periodically to L1, reducing fees and improving throughput. However, while L2 solutions do indeed enhance efficiency, they are founded upon general purpose frameworks that lack, for example, the specialized features needed to address the frequent real time, device-driven micro payments forecasted for IoT and M2M environments.

The issues clearly are nuanced and complex. But overall, the fundamental problem afoot is perceived two-fold: (1) It is foreseen that the highly desirable expansion of IoT and M2M network functionality will be stunted by fees disproportionately high relative to the modest amounts of value being exchanged frequently between participating device nodes; and (2) alternative payment solutions available through decentralized blockchain technology are currently ill-suited to provide an adequate remedy and are currently unknown and uncontemplated.

### SUMMARY

In response to the above problem, the present invention provides a versatile, customizable device-facing service interface (i.e., a “Layer-3” service interface), installed within a broader electronic digital network or system, that is configured to augment, hybridize, and couple extant Layer-1 and Layer-2 blockchain technologies operating within, thereby offering or otherwise enabling advanced cost effective and decentralized pecuniary transactions among any enrolled, subscribed, and/or otherwise participating IoT and/or M2M device nodes active or otherwise deployed therein.

By bridging existing blockchain layers with a customizable suite of IoT/M2M-specific modules, the L-3 service interface provides a scalable and cost efficient solution for automated, decentralized commerce in machine-driven environments.

Unlike conventional blockchain-based micropayment systems, which rely solely on fixed pricing models or static heuristic-based transaction batching, the present invention through its service interface can uniquely integrate, for example, a multi-layer adaptive pricing engine, predictive routing mechanism, cryptographic zk-Rollup fraud prevention, and real-time Layer-3 transaction execution, all operating within a cohesive framework leveraging volatility-mitigating stablecoins, smart contracts, Layer-2 scaling solutions, and machine learning to adjust cost efficiency, processing speed, and transactional security in IoT micropayment environments.

In preferred implementations, the Layer-3 service interface is engineered to integrate and orchestrate functionalities—such as device authentication, transaction routing, on-demand pricing, and micropayment batching—to substantially improve autonomous device access to extant L-1 and L-2 blockchain infrastructure resources. These and other L-3 functionalities are customizable, in both breadth and in depth, to suit the particular demands of smart device networks and the capabilities of extant L-1 and L-2 technologies.

A key feature in several embodiments of the new L3-mediated approach is the use of hardware accelerated cryptography to enhance authentication speed and efficiency, addressing bottlenecks common in high frequency micropayment environments. If demanded or desired, the integration of ephemeral cryptographic tokens (i.e., secured, short lived, transaction bound digital credentials issued by the interface after decentralized identifier verification) can also improve transactional security by reducing the attacks and risk of replay streamlining the micropayment process. Combining both hardware accelerated cryptography and ephemeral cryptographic tokens can even better foster secure real-time transactions tailored to meet the predicted pecuniary demands of rapidly expanding IoT and M2M networks.

Other key service interface functionalities can be provided by integration of an AI-drive pricing engine and a distributed hash table based service registry. The AI-driven dynamic pricing engine can be engineered, for example, to support real time fee adjustments to pricing for data and services including but not limited to: energy usage, parking time, sensor data, bandwidth, compute power, authentication, software updates, cloud storage, API access, vehicle tolls, advertising delivery, environmental adjustments, maintenance services, drone tasks, supply chain logistics, supply-demand data, blockchain congestion metrics, and historical transaction analytics. The distributed hash table based service registry can be engineered, for example, to effect substantially instantaneous acquisition of device authentication records, active service offers, and ephemeral authentication tokens without resorting to a single, centralized data repository.

Several system, method, and hardware embodiments—all incorporating some or all of the customizable service interface functionalities—are contemplated.

In respect of hardware embodiments, the invention provides in general a preconfigured Layer-3 blockchain service interface device, such a as dedicated server. The service interface device is engineered for installation within an electronic network and comprises at least: A processor, a data input port, a data output port, and blockchain transaction programming. The blockchain transaction programming includes instructions for (a) communicating and interoperating with pre-specified Layer-2 and Layer-1 blockchain services accessible on the host electronic effecting a pecuniary transaction between said smart device nodes based on said communication and interoperation with the Layer-1 and Layer-2 blockchain services. A service registry and access control module are preferably provided to enable decentralized authentication of participating device nodes through the issuance and validation of portable cryptographic authentication tokens.

The system and method embodiments-though different in their particulars-generally follow the overall contours of the hardware embodiments, bridging smart devices on the one hand and blockchains on the others.

In light of the above, it is a principle object of the invention to provide a blockchain service interface that facilitates advanced, cost efficient pecuniary transactions among participating IoT and M2M device nodes, with a particular focus on optimizing, improving, or otherwise promoting the aggregation and processing of high volume micro transactions at scale.

It is another particular object of the invention to provide a service interface driven methodology for mediating pecuniary device micro transactions involving (a) a decentralized authentication of smart device nodes and (b) a “fit-to-function” utilization of blockchain-based “smart contract” technology.

It is another object of the invention to provide a network installable Layer-3 blockchain service interface suited for efficiently mediating between extant Layer-1 and Layer-2 blockchain technologies and participating IoT and/or M2M devices, and in doing so to register and authenticate said smart devices for the purpose of conducting thereamongst advanced, cost effective pecuniary transactions.

It is another particular object of the invention to provide a hybridized blockchain system comprising a device-facing pecuniary-transaction service interface, co-existing Layer-1 and Layer-2 blockchain technologies, and participating IoT and/or M2M device nodes; whereby pecuniary transactions among participating device nodes are securely enabled.

These and other objects of the present invention can be better understood in view of the detailed description herein, read in conjunction with the attached drawings.

### BRIEF DESCRIPTION OF THE DRAWINGS

FIG. 1 schematically illustrates, in accordance with an embodiment of the present invention, an electronic network 10 utilizing a blockchain service interface 100.

FIG. 2 schematically identifies certain notable components of a blockchain service interface 100 pursuant to certain inventive embodiments thereof.

FIGS. 3 to 8 schematically illustrate, pursuant to one mode of practicing the invention, certain notable steps for effecting a pecuniary transaction related to service provision between a first IoT or M2M device node 410a and a second IoT or M2M device node 410b utilizing a blockchain service interface 100.

### DETAILED DESCRIPTION

Attention is directed initially to the basic method for conducting electronic pecuniary transactions according to the present invention. The method, simplified here at the outset to facilitate understanding, comprises four basic stages: (a) preparation, (b) initiation, (c) processing, and (d) execution.

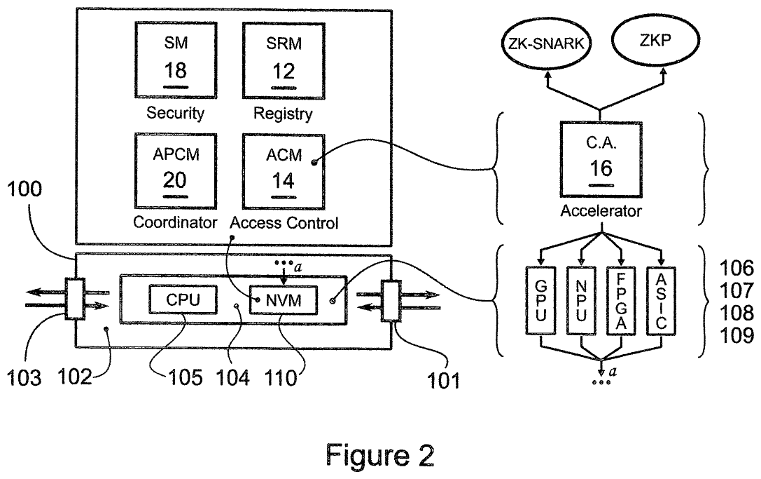

The “Preparation Stage” generally involves, at the least, the installation, or activation otherwise provision of a layer-3 blockchain service interface within a public or private electronic network that also includes a layer-1 blockchain service and a layer-2 blockchain service and networked IoT/M2M device nodes accessible and operating therein. An example of “preparation” would be the procurement or manufacture of a dedicated blockchain interface server 100 (such as disclosed in FIG. 2), followed by the installation thereof within said electronic network. As used herein, other and like activities within the “Preparation” stage shall include all activities effecting, but prior to, a specific service request for a pecuniary transaction by a smart device.

The “Initiation Stage” generally involves the receipt—at the Layer-3 blockchain service interface 100—of “purchase instruction data” transmitted from one of the networked device nodes. The purchase instruction data can include, but is not limited to, encoded source information, sender account information, product or service information, supplier information, receiver account information, date and time, and purchase price, quantity, and terms. As used herein, other and like activities within the “Initiation” stage include activities undertaken that are specific to the initiation of a service request for a pecuniary transaction at the Layer-3 service interface 100.

The “Processing Stage” generally involves processing the purchase instruction data received at the Layer-3 blockchain service interface 100 pursuant to its “blockchain transmission programming. As a result, the service interface 100 generates and transmit a blockchain service instructions to the Layer-2 blockchain service to interoperate with the Layer-1 blockchain service. The blockchain service instructions are based on the received purchase instruction data and include a further instruction to the Layer-2 block chain. 30 to transmit back “sale instruction data”. As used herein, other and like activities within the “Processing” stage shall include all activities undertaken to carry out the service request for a pecuniary transaction, subsequent to its initiation, but prior to its execution.

The “Execution Stage” generally involves receiving and processing the sale instruction data at said Layer-3 blockchain service interface 10 and thereafter communicating or otherwise effecting the results thereof at the device nodes. As used herein, other and like activities within the “Execution” stage shall include all activities undertaken to execute the service request for a pecuniary transaction after a programmed vetting thereof and commitment thereto.

If all predetermined requirements are met, what ensues apart from consummation of the requested pecuniary transaction is myriad, depending on the device network and context: e.g., the lifting of a gate arm; the dispensation of a can of soda; the entry of a tick mark into a ledger; the mobilization of warehouse robots to retrieve a product, package it, and ship it; the opening of a valve at a gas station pump; the unlocking of a subroutine or downloadable content on an online game; the charging of an electric vehicle, and the transfer of freight at shipping port junctions.

As will be appreciated, the “basic” method above is vastly simplified. In practice, the stages mentioned may not in all instances proceed in a rigid and linear chronological sequence. In several modes, for example, the “initiation” and “processing” stages can occur in a piecemeal fashion, involving staggered volleys of data exchanges between the nodes, the blockchains, and the service interface. Similarly, in other modes, the overall process may not fully terminate at the “execution” stage. “Post-execution processing” can occur.

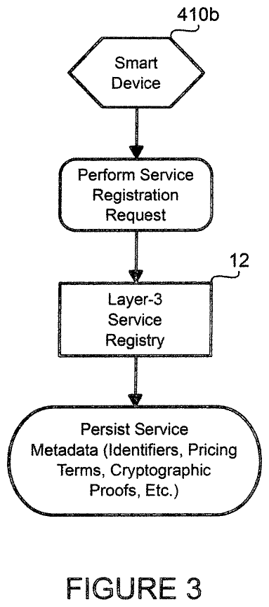

In certain preferred modes of practicing the invention, additional steps and/or processes within each of the “basic” stages are present and merit attention. In several of such modes, for example, authentication and the use of decentralized identifiers—not touched upon above—are key. These and other processes are discussed with reference to FIGS. 3 to 8.

Attention is first directed to preferred modes of practicing the “Preparation” stage.

In addition to deployment, the Layer-3 service interface 100 is, in the course of its selection and/or installation, engineered or programmed to provide one or more of the following objectives: Maintaining a real-time service registry; effecting decentralized authentication via an access control module; dynamically updating service pricing via an adaptive process coordination module; and managing escrow-based transactions.

Along these lines, in preferred modes of practice, a dedicated blockchain interface server 100 is engineered and installed to enable distributed authentication of participating smart device nodes using “decentralized identifiers” (DIDs) and other cryptographic mechanisms. In addition to the immediate discussion of DIDS in respect of methodology, additional details of the nature, identity, and function of such DIDS are provided much further below in reference to the inventive system and hardware embodiments.

To supplement and/or aid said objective of dynamic pricing, the dedicated Layer-3 service interface 100 is also preferably preprogrammed, at said adaptive coordination module, register so-called “smart contracts” on the Layer-2 blockchain for price verification, escrow contract management, and dispute resolution.

To supplement and/or aid said objective of maintaining a real-time register of services, the dedicated Layer-3 service interface 100 is also preprogrammed, at said service registry, to enable smart device nodes to register available services without disclosing specific transaction details, thereby streamlining downstream processes.

FIG. 3 provides a flowchart exemplifying a process for pre-registering services that are available to any particular participating smart device node. As shown, prior to any initiation of a pecuniary transaction, the smart device node 410b is prepared for duty by pre-registering its services in the service registry 12, preferably including the following metadata information: decentralized identifier (DID) of device 410b; service identifier (Service Hash ID); pricing details that are dynamically updated based on AI-driven models and pricing oracles; and cryptographic proofs validating service authenticity.

Attention is now directed to preferred modes of practicing the “Initiation” stage.

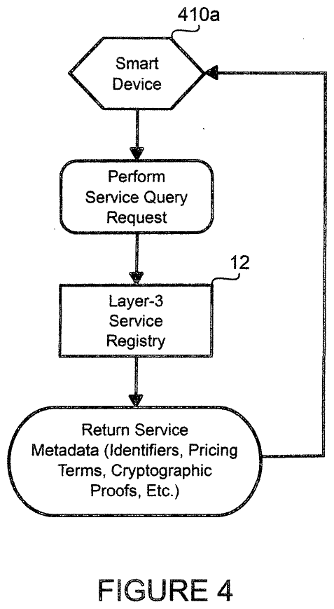

As shown in FIG. 4 (which provides a flowchart of a “Service Lookup” process), when device node 410a seeks to utilize a service provided by device node 410b, the transaction preferably begins with a “service lookup” in the Layer-3 service registry 12. Device node 410a then retrieves the most recent service pricing and verifies its ability to proceed.

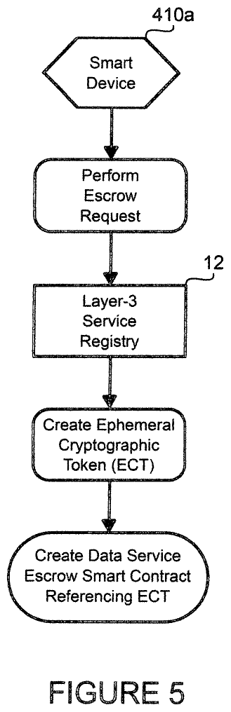

As shown in FIG. 5 (which provides a flowchart of an “Escrow Creation” process), if the requesting smart device 410a elects to continue, it communicates with the Layer-3 service interface 100 to create a data service escrow smart contract 56, which serves as the price agreement smart contract on the Layer-2 blockchain service 300. This smart contract preferably includes some or all of the following data: Pricing details retrieved at the time of lookup; cryptographic proofs of both the offered and accepted service pricing details; a record of the funds escrowed to back the service transaction; and a reference to the ephemeral cryptographic token (ECT) that will be issued. The smart contract and its included data are created such that, in the course of the ensuing “processing”, even if pricing updates occur after the agreement, the smart contract retains cryptographic validation of any terms originally agreed upon.

With the transaction “initiated”, attention is now directed to preferred modes of practicing the “Processing” stage.

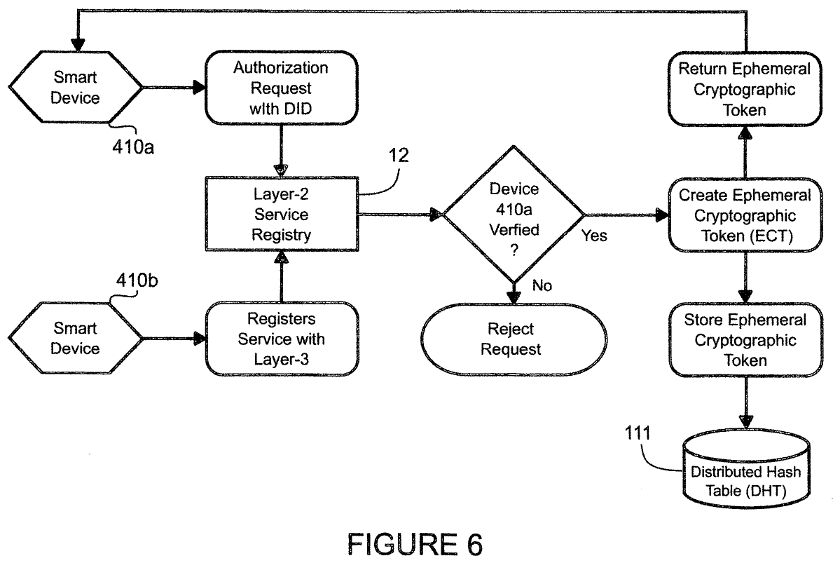

As shown in FIG. 6 (which shows a flowchart of “Decentralized Authentication”), once an escrow contract is in place, smart device 410a requests authentication via the Layer-3 service interface 100, thereby commencing the “processing” of the requested pecuniary transaction. Authentication here involves: Verifying the DID of smart device 410a using the access control module (ACM) 14; issuing an ephemeral cryptographic token that authorizes direct interaction between 410a and 410b; and logging the issued ECT linked to the escrow contract in the Layer-3 distributed hash table 111 associated with the system registry 12.

As discussed in greater detail with reference to FIG. 2, in preferred modes of practice, the access control module 14 is hardware accelerated, utilizing graphics processing units (GPUS), neural processing units (NPUs), application-specific integrated circuit (ASIC) co-processors, or field-programmable gate array (FPGA)-based logic for zero-knowledge proof computations. By offloading zk-proof generation and verification to dedicated hardware, sub-second validation times can be better achieved, even under high device throughput.

As also discussed in greater detail with reference to FIG. 2, in preferred modes of practice, the system registry 12 includes an AI-driven pricing subroutine that continuously monitors real-time congestion indicators, historical gas fee data, and device service usage to recalculate price offers on a per-transaction basis. This ensures to a considerable extent that ephemeral tokens minted under high-load conditions reflect updated cost structures, preventing or otherwise mitigating mispriced micropayments. Where implemented, the AI-driven pricing subroutine can be based on both transactional load conditions and the market value of data itself.

Following successful processing involving the authentication and verification of services and devices, execution of the requested pecuniary transaction commences. Attention is directed to preferred modes thereof.

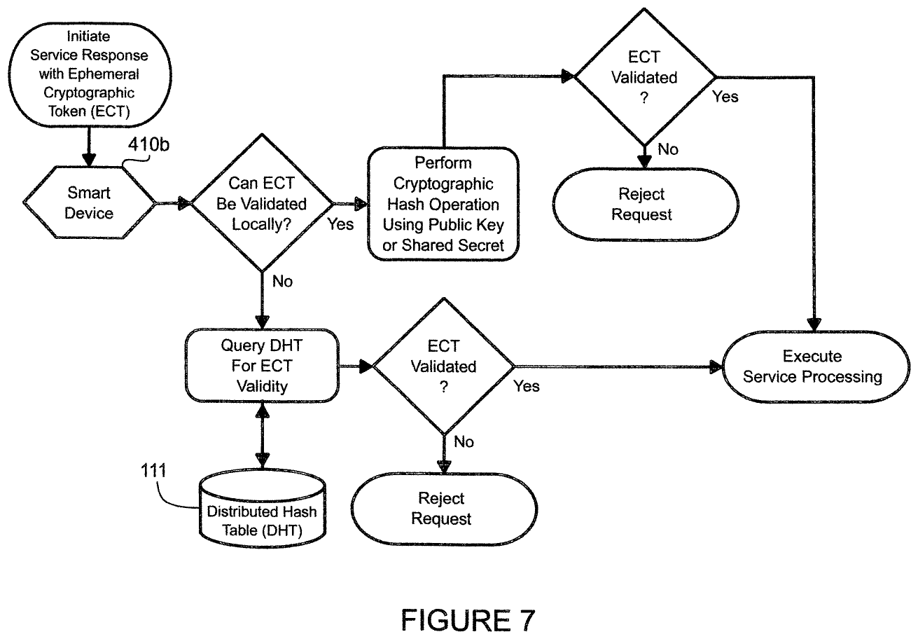

As shown in FIG. 7, subsequent to the creation of its requested ECT, the smart device node 410a then transmits the ECT and escrow reference to smart device node 410b to initiate the service. Smart device 410b then validates the ECT using the security module 18 and confirms its ability to deliver the requested service.

To optimize both security and efficiency, a hybrid validation approach can be employed to allow smart device node 410b to first attempt a local hashing-based ECT verification before querying the DHT when needed. This flexible mechanism ensures that transactions can proceed with substantially reduced latency under normal conditions while retaining the ability to escalate to a more robust verification process for high-value or suspicious transactions.

Such an approach promotes low-latency validation for transactions where computational efficiency is prioritized over distributed verification. However, if a token appears anomalous, expired, or requires additional security assurances, the method can also be programmed to dynamically escalate to a DHT query for enhanced verification.

Upon validation, smart device node 410b processes the service request according to its defined parameters. This may involve, for example: Data generation and delivery; device actuation or interaction; and secure exchange of digital resources. If the requested service requires data transfer, it can be programmed to occur exclusively between device node 410a and device node 410b, without passing through the Layer-3 service interface 100.

In certain modes of practicing the inventive particular routines that involve “service outcome methodology, provision is made for acceptance”, “dispute processing” and “escrow fund release”.

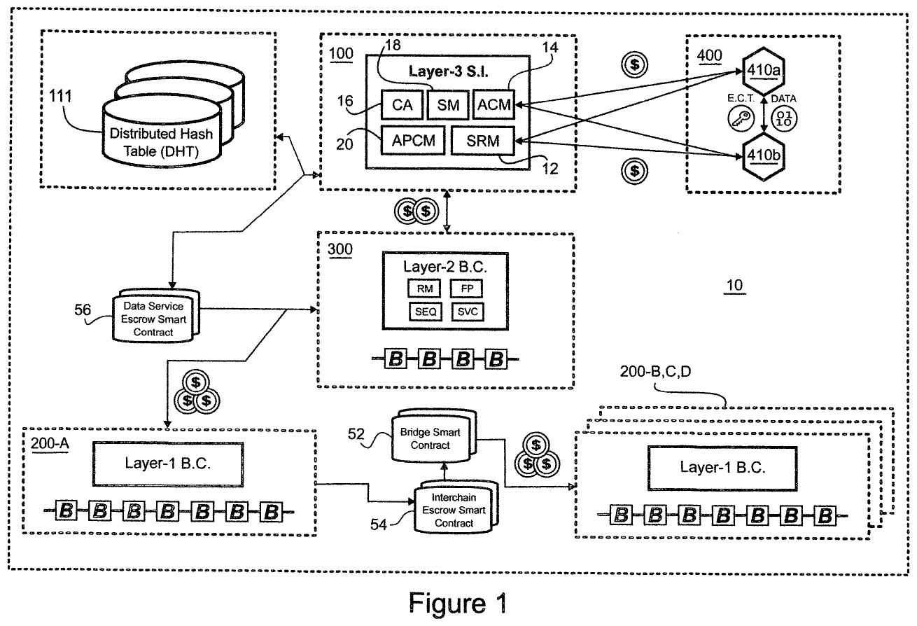

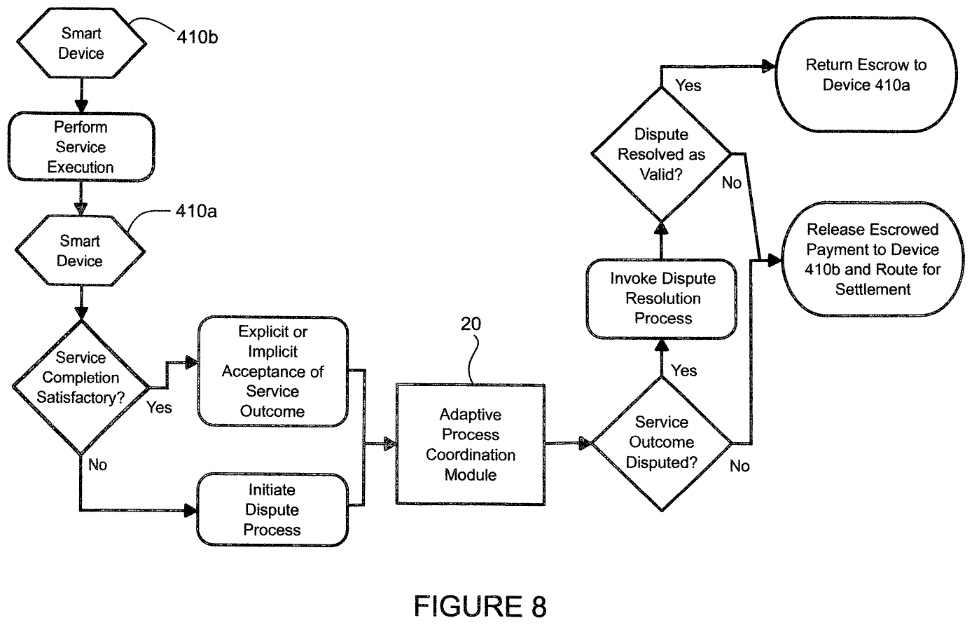

As shown in FIGS. 1 and 8, a data service escrow smart contract 56 can be implemented to govern dispute resolution and final settlement. This contract maintains the cryptographic proofs of agreed-upon pricing and service details, attestation data from both devices to validate the service outcome, and Zero-knowledge proofs (ZKPs) or multi-signature validation methods

Once the requested service is completed, device node 410a has an opportunity to validate and accept the service outcome. If the service execution aligns with the expected conditions, device 410a confirms acceptance either explicitly or via an implicit time-based mechanism, depending on the service terms stated in the service registry detail.

If the smart device 410a accepts the service: The method is programmed to enable the escrow contract to trigger the automatic release of funds to smart device 410b via the adaptive process coordination module 20 of the Layer-3 service interface 100. The module 20 ultimately finalizes and rolls up the transaction through the Layer-2 rollup mechanism (RM) using zk-Rollups or Optimistic Rollups.

Before submission to the Layer-2 blockchain 300, the Layer-3 service interface 100 can be programmed to aggregate and batch multiple micropayments, fraud detection mechanisms and transaction validation processes. This ensures that Layer-2 only processes pre-verified and optimized payment data, reducing network congestion and gas fees.

Similarly, the Layer-3 service interface can also be programmed to batch micropayment instructions originating from multiple IoT or M2M devices, grouping them for a single rollup submission on the Layer-2 network. Such approach can reduce on-chain fees by leveraging partial off-chain or sidechain computations, while eventually committing a final state to the Layer-1 blockchain at a more cost-advantageous time.

If the smart device 410a disputes the service: The escrow contract triggers a deterministic dispute resolution process, using cryptographic proofs of service execution, audit trails stored in Layer-2, and multi-party cryptographic attestations.

If the dispute is validated, funds may be refunded to 410a.

If the dispute is invalid, funds are released to 410b.

The final dispute resolution record is stored immutably via Layer-2 dispute resolution functionality provided by the data service escrow smart contract 56.

Attention is now directed to certain notable programmable interactions between so-called “pricing oracles” and the service registry module 12 that can, if incorporated, effect beneficially the performance of the inventive method.

To better ensure real-time pricing accuracy and prevent or otherwise mitigate outdated or manipulated service rates, the Layer-3 service registry 12 can be programmed to interact with decentralized on-line pricing oracles (not depicted) that provide real-time market data. These pricing oracles serve two key purposes: “Determination of Data Service Pricing” and “Fraud Prevention and Anomaly Detection”.

In regards to the determination of data service pricing, the service registry 12 is programmed to continuously query decentralized pricing oracles for real-time data service pricing updates and record the data resultant thereof. AI-driven models use this data to dynamically adjust service pricing based on historical service usage trends, network demand and congestion levels, and competitive pricing benchmarks. The updated service pricing data is cryptographically signed and stored in the distributed hash table (DHT) 111 to promote transparency and mitigate tampering. Further details and discussion is provided below in reference to FIG. 2.

As is known, certain online pricing oracles are capable of monitoring Layer-1 and Layer-2 blockchain networks to track gas fees for transaction execution and congestion levels affecting transaction finalization times. Such information can be incorporated to enable the adaptive process coordination module 20 to improve transaction rollups, adjust transaction fee estimates dynamically, and/or determine cost-effective timing for Layer-1 finalization.

To promote fraud prevention and anomaly detection, the method can be designed to leverage zero-knowledge proofs (ZKPs) and anomaly detection models to flag suspicious pricing updates. In cases of detected inconsistencies, the Layer-3 service interface 100 can also be programmed to prioritize oracle sources with higher trust scores and disregards unreliable data.

By integrating pricing oracles for both service pricing and blockchain transaction cost estimation, the Layer-3 service interface 100 ensures that all service transactions reflect real-time, tamper-resistant, and verifiably accurate economic conditions, reinforcing trust and fairness in IoT-driven micropayment ecosystems.

By consolidating pricing agreement validation, escrow enforcement, and cryptographic dispute resolution into a single contract structure, the Layer-3 service interface 100 is well suited to deliver trustless, automated transactions without requiring direct pricing negotiation between devices.

Attention is now directed to FIG. 1.

In contrast the method disclosed in reference to FIGS. 3 to 8, FIG. 1 discloses more particular details of an overall system 10 that carries out said method. Tracking many of the features of the method, the system 10 at its core also involves the automated execution of pecuniary transactions between “intelligent devices” (e.g., IoT devices, M2M devices, and like smart devices) through the agency of the inventive Layer-3 service interface 100.

FIG. 1 schematically depicts an electronic system 10 comprising four identifiable subsystems: the “intelligent devices” subsystem 400, the Layer-2 blockchain subsystem 300, the Layer-1 blockchain system 200, and the Layer-3 service interface 100.

The intelligent device subsystem 400 comprises in general at least two, but in practice several, intelligent devices capable of autonomously communicating, sensing, sharing, and interoperating with each other for individual or collective tasks. For purpose of illustration, two are disclosed in FIG. 1: device node 410a and device node 410b. In the illustration, node 410a represent, for example, a first smart device (e.g., an RFID device, a printer, a smart phone or smart watch, an industrial supply sensor, etc.) and node 410b represents a second smart device (e.g., an RFID sensor, an ink supplier server, a retail merchant server, an industrial supplier server, etc.)

Within the system 400, upon an automatically triggered request from device 410a, a pecuniary transaction is effected between node 410a and node 410b involving the sharing of data and access amongst the nodes in exchange for electronic monetary value. As used herein, a pecuniary transaction shall be defined as any exchange of goods or service for a monetary value. In the case of this invention, the monetary value is based on electronic blockchain currency.

Initiation of the pecuniary transaction occurs for example, when node 410a electronically senses a predetermined and pre-scripted condition that requires an automated response from node 410b. Examples of such conditions include, but are not limited to, proximity, low ink level, smart phone user input, or a supply level beyond a predetermined value. Upon sensing such condition, node 410a communicates both with 410b and the layer-3 service interface 100, providing and sharing with each the necessary data and authentications to initiate and prepare for the pecuniary transaction.

Those skilled in the art will appreciate that in practicing the invention the intelligent device nodes can function both as a merchant device or a customer device for different pecuniary transactions. For example, for one transaction one node serves as a merchant and, for another transaction, as a customer.

As for the smart device nodes, as mentioned earlier, two types are currently being expressly considered: smart devices hosted on an IoT network and smart devices hosted on an M2M network. Those skilled in the art are well aware of the rapidity with which standardized protocols change. As such, no limitation within the spirit of the claims below should be inferred that would otherwise fail to accommodate such change.

The scientific literature is replete with detailed information about IoT devices, their manufacture and functions and deployment: See e.g., R. A. Mouha, “Internet of Things”, Journal of Data Analysis and Information Processing, 2021, 9, 77-1010; D. Berte, “Defining the IoT”, Proc. Int'l Conf. Bus. Exec. May 2018, p. 118-128; S. Nižetić et al., “Internet of Things (IoT): Opportunities, Issues and Challenges towards a Smart and Sustainable Future”, Journal of Cleaner Production, Vol. 274 (2020) 1222877; and S. Kumar et al., “The Internet of Things is a Revolutionary Approach for Future Technology Enhancement: A Survey”, J. Big Data (2019) 6-111. Patent literature is also a useful resource: See e.g., U.S. Pat. No. 11,392,111, issued to C. H. Cella et al. on Jul. 19, 2022; U.S. Pat. No. 11,722,528, issued to N. Ojha et al. on Aug. 8, 2023; U.S. Pat. No. 10,973,014, issued to W. Chang et al. on Apr. 6, 2021; U.S. Pat. App. Pub. 2022/0141662, applied for by C. Liao and published on May 5, 2022; and U.S. Pat. No. 9,015,329, issued to W. H. Chang et al. on Apr. 21, 2015.

For further information regarding certain topical M2M networks, see e.g.: M. Chen et al., “A Survey of Recent Developments in Home M2M Networks,” in IEEE Communications Surveys & Tutorials, vol. 16, no. 1, pp. 98-114, First Quarter 2014; J. Brazell et al., “M2M: the wireless revolution.” (2005); N. Anumbe et al., “A Primer on the Factories of the Future.” Sensors 22.15 (2022): 5834; and D. Strugar et al., “An architecture for distributed ledger-based M2M auditing for electric autonomous vehicles.” Web, Artificial Intelligence and Network Applications: Proceedings of the Workshops of the 33rd International Conference on Advanced Information Networking and Applications (WAINA-2019) 33. Springer International Publishing, 2019. See also: U.S. Pat. No. 10,631,149, issued to S. Palanisamy et al. on Apr. 21, 2020; U.S. Pat. No. 10,791,171, issued to Q. Li et al. on Sep. 29, 2020; U.S. Pat. No. 10,455,386, issued to Y. Huang on Oct. 22, 2019; U.S. Pat. No. 9,271,139, issued to H. Zhou et al. on Feb. 23, 2016; and U.S. Pat. No. 9,210,527, issued to G. Cherian et al. on Dec. 8, 2015.

Consistent with the discussion hereinabove (i.e., with respect to methodology), the request to effect a pecuniary transaction, initiated by the first smart device 410a (cf., the “requesting device”), preferably involves transmission of an authentication request and cryptographic proof to the Layer-3 service interface 100. The service interface 100 verifies the authenticity of the requesting device 410a and, upon successful verification, issues an ephemeral cryptographic token (ECT) enabling direct interaction between 410a and 410b.

Both smart device 410a and smart device 410b are preferably pre-programmed with code that assures proper formatting of data and network addressing suited for reception at the service interface 100, such as by installation of an API downloaded onto a device or IoT network server hosting the device for purposes of enrolling a node to the service interface scheme.

Preferably, when the Layer-3 service interface 100 receives an authentication request from device node 410a, it then verifies that device's decentralized identifier and (DID) issues an ephemeral cryptographic token (ECT) upon successful authentication. This token is issued to enable device node 410a to interact directly with device node 410b for service execution while maintaining cryptographic trust in the transaction.

Separately, for pecuniary transactions, the Layer-3 service interface 100 is preferably engineered to actively manage cross-chain interactions between Layer-3, Layer-2, and Layer-1. In particular embodiments, it aggregates and batches micropayments received from multiple authenticated device nodes, optimizing (or otherwise improving) transaction finalization through zk-Rollups or optimistic rollups on Layer-2.

The Layer-3 service interface 100 is also preferably engineered to conduct fraud detection by analyzing transaction patterns and anomaly detection models before submitting aggregated transactions for final settlement. After validation, settlements are executed on Layer-1, ensuring immutability and security while reducing gas costs and improving transaction efficiency.

The preferred subcomponents of the service layer interface 100 include, but are not limited to, a service registry 12, an access control module 14, a cryptographic accelerator module 16, a security module 18, and an adaptive process coordination module 20. Details and functions of these and other components are discussed further below with reference to FIG. 2.

The communications from the Layer-3 service interface 100 is largely configured based on the known parameters and functions of pre-existing Layer-2 and Layer-1 blockchain technologies. Since Layer-2 blockchain technologies in current existence are already structured to electronically interoperate with the foundational Layer-1 blockchain technology, no reinvention of these systems is needed for the invention, though not enjoining potential restructuring for future practice. Currently, the means and method for addressing, communicating and accessing such technologies will be known to those skilled in the art, and the service interface can be configured as such.

As indicated, the Layer-3 blockchain service interface 100 is engineered to receive and execute instructions from said nodes 410a and 410b, and pursuant to said instructions, to electronically interoperate with said Layer-2 blockchain system 300, and indirectly thereby, said Layer-1 blockchain system 200. As the system 10 operates, the requested pecuniary transaction between said two computing nodes 410a and 410b is effected not only by the decentralized identifiers (DIDs), but also by the electronic interoperation between (a) said Layer-3 blockchain service interface 100 and said Layer-2 blockchain system 300 and (b) said Layer-2 blockchain system 300 and said Layer-1 blockchain system 200. Throughout the operation, no substantial human intervention is required. The operation proceeds autonomously, self-adjusts to dynamic market conditions, and incurs low service fee costs for settlement of the requested pecuniary transaction.

In practicing the invention, the roles of the service registry 12 and access control module 14 in the decentralized authentication of participating smart device nodes 400 and the concomitant processing of pecuniary blockchain-based transactions can not be understated. In preferred embodiments, the service registry 12 facilitates dynamic service discovery and pricing, while the access control module 14 facilitates secure, trustless identity verification using decentralized identifiers (DIDs). Together, these components support key objectives such as economical, scalable, and reliable transactions by reducing the need for centralized authorities, reducing overhead costs, and enhancing security in IoT and M2M networks.

Decentralized identifiers (DIDs) are cryptographically verifiable, self-sovereign identifiers enabling trustless authentication and verification of participating IoT/M2m smart device nodes 400. In contrast to traditional identity management systems that rely on centralized certification authorities (CAs) or intermediaries, DIDs allow devices to autonomously generate, manage, and control their identities. DIDs are generally implemented within the access control module 14 and service registry 12 to facilitate secure, trustless, and scalable identity verification across a distributed blockchain-based transaction network.

In certain preferred embodiments, upon initial deployment of a smart device (e.g., an IoT sensor or autonomous system), the device is programmed to generate a unique DID comprising: (a) a public-private cryptographic key pair, wherein the public key is stored within a decentralized ledger or Layer-3 blockchain service interface 100, and the private key is retained securely within the device; (b) a device metadata record, linking the DID to relevant transaction conditions, service agreements, or operational parameters stored within the service registry 12; and (c) a verifiable credential set, enabling authentication be requests to cryptographically signed and validated through a challenge-response mechanism.

Upon generation, the DID is recorded within the service registry 12, which is configured to interface with decentralized storage protocols and distributed hash tables (DHTs) for optimized lookup performance. The DID is subsequently associated with predefined service permissions, transactional limits, and authentication policies based on device type and operational requirements.

To initiate an authenticated pecuniary transaction within the electronic system 10, the requesting device node 410a transmits, for example, an authentication request to the service registry 12, including: (1) The device's DID; (2) a cryptographic proof, generated by signing a nonce using the device's private key; and (3) a service request token identifying the intended recipient device node 410b and transaction parameters.

Upon receipt, the service registry 12 preferably performs the following verification steps: (1) Retrieval of the corresponding public key from the decentralized DID registry or Layer-3 blockchain service interface 100; (2) validation of the cryptographic proof by verifying the signature against the stored public key; (3) cross-checking of service permissions and transactional constraints as defined in the pre-registered metadata record; and (4) authorization of transaction execution upon successful validation and cross-checking, granting the device a cryptographic authentication token enabling secure peer-to-peer communication with the recipient node 410b.

This preferred authentication process occurs prior to any execution of financial transactions, service provisioning, or smart contract interaction, ensuring that only verified devices may participate in blockchain-based micropayments or automated data exchanges.

It will be appreciated that this is only the currently preferred authentication process. Other processes can be developed based on and expanding upon the teaching set forth herein.

In certain embodiments, as shown in FIG. 1, the DID-based authentication is integrated with escrow smart contracts deployed on the Layer-2 blockchain system 300 to enhance transaction security. In this regard, upon a service request initiated by device node 410a, the following steps are taken: (1) An escrow contract is created, locking funds until the required cryptographic proof of service fulfillment is provided by device node 410b, independent of the Layer-3 service interface; (2) the recipient node 410b authenticates against the service registry 12 before claiming escrowed funds, ensuring that only verified devices participate in transactions; and (3) upon successful authentication and cryptographic attestation of service fulfillment—submitted directly by the interacting nodes—settlement is finalized on-chain. This mechanism enables fraud-resistant, decentralized settlement of IoT and M2M transactions without requiring real-time oversight or involvement by the Layer-3 service interface during service execution.

To further enhance security and scalability, the access control module 14 can also be engineered to employ zero-knowledge rollups to validate transactions off-chain while preserving cryptographic integrity. The authentication process, in such embodiment, occurs as follows: First, multiple DID authentication requests are aggregated into a single zk-proof, significantly reducing the on-chain computational burden. Second, the zk-proof is submitted to the Layer-2 blockchain system 300 for validation, whereupon all associated authentication events are deemed substantially finalized. And third, fraudulent or unauthorized transactions are flagged, and associated device nodes are subject to exclusion from future service registry operations.

By employing zk-Rollups, the system ensures high-throughput authentication while minimizing blockchain transaction fees, making DID-based verification economically viable for high-frequency micro transactions.

The integration of DIDs, the access control module 14, and the service registry 12 within the disclosed invention achieves certain technical advantages. First, decentralized, trustless authentication is promoted by substantially eliminating reliance on centralized identity providers, reducing vulnerability to data breaches and single points of failure. Second, scalability for high-frequency transactions is substantially improved enabling massive of IoT and M2M devices to authenticate rapidly using off-chain validation and zk-Rollup aggregation. Third, seamless integration with smart contracts ensures that only verified entities engage in blockchain-based transactions, reducing risk of fraud. Fourth, interoperability with cross-chain identity systems is promoted inasmuch as authentication across multiple blockchain networks is broadly enabled through the Layer-3 blockchain service interface 100.

The disclosed DID-based authentication system provides an efficient, scalable, and secure mechanism for enabling autonomous, cryptographically verifiable transactions among IoT and M2M devices, ensuring low-cost and reliable authentication in decentralized financial and data exchange environments.

In FIG. 1, the service registry 12 is preferably engineered to serve as a dynamic, continuously updated directory that manages the availability, pricing, and authentication status of services within a decentralized network. In the context of preferred embodiments of the invention, the service registry 12 preferably operates in real time, meaning it reflects the most current state (i.e., as far as technically possible and feasible) of participating IoT and M2M devices, service providers, and market-driven pricing models.

The service registry 12 is preferably programmed to enable substantially instantaneous service discovery (cf., whereby participating smart devices can query the registry 12 for available services and receive responses based on current system condition); dynamic pricing updates (cf., whereby smart contract within the registry can autonomously adjust pricing based on real-time supply-demand fluctuations; and authentication and access control (cf., whereby participating smart devices attempting to access a service can be verified against the most recent authentication data, preventing outdated or revoked credentials from being exploited).

In contrast, a non real-time service registry, would maintain static or periodically updated service information. This type of registry would require scheduled updates. As service records may be updated at predefined intervals, availability or pricing information may not always be current. Further, delays in service execution can be expected. For example, if a device queries the registry for a service, the information retrieved might be outdated, leading to inefficiencies or failed transactions. Finally, without real-time capabilities, the service registry would be less suitable for dynamic markets. Systems with variable pricing or fluctuating service availability, such as characteristic of IoT/M2M-based micro transactions, are better served through continuous updates, which a non real-time registry cannot easily provide if at all.

A real-time service registry ensures that IoT and M2M devices operate in a low-latency, dynamically adaptive environment, crucial for decentralized and automated transaction ecosystems. In contrast, a non real-time registry is better suited for systems where service conditions remain relatively stable or where periodic updates are sufficient. Regardless, the real-time nature of the service registry 12 enables (in preferred embodiments of the invention) seamless, efficient, and trustless interactions in a decentralized financial and service exchange system.

So-called “pricing oracles” can play a substantial role in decentralized systems, particularly those involving IoT and M2M transactions, by dynamically determining service costs based on real-time market conditions, demand fluctuations, and resource availability. To achieve this, the invention can be engineered to incorporate a real-time pricing mechanism that continuously updates and provides verified pricing information to smart contracts and service registries, ensuring that transactions reflect current economic conditions.

A pricing system in this context functions as a decentralized or semi-decentralized source of pricing data that enables autonomous service agreements. It allows devices and services to negotiate fair, market-driven rates without reliance on fixed pricing models or centralized pricing authorities. These systems aggregate pricing data from multiple sources, including blockchain transactions, external market feeds, and smart contract-driven auctions; they provide real-time fee adjustments based on demand-supply conditions, network congestion, and historical pricing trends, and they enable automated service agreements, allowing devices to verify pricing before executing a transaction via a smart contract.

Within the disclosed system 10, the service registry 12 preferably communicates with decentralized pricing sources via a real-time data feed interface. This enables: “Autonomous Market Pricing”; “Smart Contract Integration”; and “Transaction Cost Optimization”.

In regards to “Autonomous Market Pricing”: the system 10 can be arranged such that when an IoT device (e.g., node 410a) requests a service, the service registry 12 retrieves the latest service fee data, largely ensuring that the transaction is based on substantially current conditions.

As for said “Smart Contract Integration”, the system 10 can also be programmed such that real-time pricing data is autonomously and continuously fed into the Layer-3 blockchain service interface 100, triggering corresponding dynamic updates to any or all of a predefinable set of smart contract parameters.

As for said “Transaction Cost Optimization”, the system 10 can also be programmed such that the access control module 14 cross references pricing data with historical transaction costs to substantially prevent or otherwise frustrate price manipulation or outdated fee assessments.

Decentralized pricing mechanisms, which are also usefully incorporated into system 10, are commonly used in DeFi (Decentralized Finance) protocols and blockchain-based marketplaces. Some established implementations include, but are not limited to: “Chainlink (LINK)” (a decentralized network that provides external pricing data to smart contracts); the “Pyth Network” (an aggregator of financial data from institutional traders for on-chain use); and “api-based pricing models” (see e.g., “The Graph”, available online at <https://thegraph.com>) that enable decentralized indexing of real-time financial data for use in smart contract technology.

While current decentralized pricing systems rely on external oracles or aggregated data sources, future implementations may leverage: “Machine Learning Models” (i.e., predictive algorithms that adjust service pricing dynamically based on usage patterns and network conditions); “Peer-to-Peer Marketplaces” (i.e., direct device-to-device price negotiation that eliminate the need for third-party data providers; and “Layer-2 Data Verification” (i.e., smart contract-driven pricing models that reduce reliance on external feeds by batching multiple price updates off-chain before submitting validated data to the Layer-1 blockchain).

Rather than relying on rigid, fixed pricing models, this preferred embodiments of system 10 employs a real-time, market-driven pricing mechanism that ensures fair, efficient, and cost-adjusted transactions for IoT and M2M services. The integration of automated, on-chain pricing adjustments enables seamless interaction between devices while maintaining a trustless, decentralized economic framework.

As shown in FIG. 1, the service interface 100 is provided with an adaptive process coordination module 20, which is discussed in greater detail with reference to FIG. 2. In general, the APCM 10 is a the preferred functional component within system 10 that is configured to enhance transaction efficiency, minimize computational overhead, and optimize resource allocation for decentralized financial interactions. Operating in conjunction with the access control module 14, security module 18, and service registry 12, the adaptive process coordination module 20 is programmed to ensure that micropayments and service transactions are executed at minimal or otherwise lower latency and cost.

Upon receipt of a service request from a participating device (e.g., node 410a), the adaptive process coordination module 20 is preferably programmed to perform one or more of the following functions: “Transaction Routing Selection”; “Batching and Rollup Implementation”; and “Dynamic Fee Adjustment”.

For the “Transaction Routing Selection” function, the adaptive process coordination module 20 is programmed to determines whether a given transaction should be processed through Layer-2 scaling mechanisms 300 or settled directly on Layer-1 blockchain infrastructure 200, based on real-time network conditions and cost-efficiency metrics.

For the “Batching and Rollup Implementation” function, the adaptive process coordination module 20 aggregates multiple micropayment transactions into a single batch before submission to the blockchain, thereby reducing on-chain transaction fees and improving throughput.

For the “Dynamic Fee Adjustment” function, the adaptive process coordination module 20 is programmed to Interface with a pricing oracle system (as discussed hereinabove) to adjust transaction parameters based on fluctuating service costs, network congestion, and demand.

As illustrated in FIG. 3, transaction execution is distributed across both the Layer-2 blockchain system 300 and the Layer-1 blockchain system 200. The adaptive process coordination module 20 is designed to leverage AI-driven optimization models that dynamically determine the most suitable execution path based on real-time and historical transaction data. The APCM 20 is thus preferably programmed to provide any or all of the following functions at extents and degrees deemed feasible or otherwise desirable:
1. Predicting optimal settlement paths by analyzing historical congestion patterns, transaction fees, and execution times, continuously refining its decision-making models;
2. Identifying low-cost settlement opportunities within Layer-2 rollups, ensuring transactions are batched efficiently to minimize gas fees and reduce transaction finality time;
3. Implementing off-chain validation techniques, including zk-Rollups and Optimistic Rollups, to maximize throughput while maintaining cryptographic security guarantees;
4. Monitoring network congestion levels in real-time, dynamically redirecting transactions between Layer-1 and Layer-2 infrastructures as needed to avoid high-fee execution paths;
5. Employing fraud detection algorithms to assess risk levels in pending transactions, with higher-risk transactions undergoing additional verification steps or multi-signature validation before being included in rollup batches; and
6. Algorithmically controlling transaction batching and prioritization, ensuring that urgent micropayments are finalized faster while lower-priority transactions are aggregated for cost efficiency.

The adaptive process coordination module 20 is further preferably configured to allocate system resources dynamically, ensuring efficient service delivery in IoT networks with constrained computational and energy resources. This can include, for example: Prioritization of time-sensitive transactions, ensuring real-time authentication and service execution where required; load balancing across processing nodes, distributing cryptographic verification tasks and authentication workloads to prevent bottlenecks, and caching and predictive pre-processing, reducing repetitive computational overhead by leveraging previously authenticated transaction data.

To maintain transaction integrity and fraud resistance, the adaptive process coordination module 20 can be programmed to collaborate with the security module 18 and access control module 14 to, for example: cross validate service provider authentication records against the service registry 12 before initiating transactions; employ anomaly detection algorithms to flag suspicious or unauthorized device activity; and implement multi-signature authentication mechanisms for high-value transactions, ensuring trustless settlement between service nodes 410a and 410b.

As evident from the plethora of the above disclosed alternatives, the adaptive process coordination module 20 is quite versatile, enhancing the scalability, efficiency, and cost effectiveness of the disclosed micropayment platform by dynamically adjusting transaction execution pathways, optimizing blockchain settlement processes, and intelligently managing resource allocation. Its integration with Layer-2 scaling solutions and decentralized authentication mechanisms ensures seamless operation in IoT-driven financial ecosystems while reducing transaction fees and improving system throughput.

As shown in FIG. 1, the inventive system 10 preferably employs a “distributed hash table (DHT) 111, within or otherwise associated with the service registry 12, to facilitate decentralized storage and retrieval of authentication records, service metadata, and pricing information. This architecture enables real-time service discovery and authentication without relying on a centralized authority.

In certain embodiments, the service registry 12 can be programmed to organizes key-value pairs in the DHT structure 111, wherein: keys represent unique identifiers for smart nodes (e.g., devices 410a, 410b) or service providers; and values store authentication credentials, service parameters, pricing details, and access permissions.

In such embodiments, when a service request is made, the access control module 14 or a requesting device queries the DHT 111 and the following process ensues: The requesting device hashes the identifier of the service or entity it seeks; and the system 10 then routes the request through the DHT 111 to locate the corresponding node storing the required metadata; whereupon the retrieved authentication or service data is verified cryptographically before authorizing the transaction.

Through such and like embodiments, the DHT 111 provides means for efficient, low-latency lookups for authentication and service discovery, without the necessity of locally storing transaction-specific financial commitments. Instead, once a service request is initiated, device node 410b can record pricing and execution commitments elsewhere in, for example, a “price agreement” smart contract on the Layer-2 blockchain 300, ensuring immutability and enforceability.

If device node 410a disputes service execution, resolution can be handled cryptographically rather than through centralized arbitration. The system references immutable commitments in the price agreement smart contract, leveraging, for example: Zero-knowledge proofs (ZKPs) or multi-signature attestations to confirm service validity; Layer-2 dispute resolution contracts to ensure finality; and automated escrow enforcement, where funds are either released to device node 410b or refunded to device node 410a, depending on fulfillment status.

By keeping the DHT 111 in certain embodiments focused on service discovery and authentication, while Layer-2 enforces financial commitments, the system 10 can maintain decentralized flexibility and trustless execution.

As shown in FIG. 1, the DHT-based service registry 12 preferably interacts with Layer-2 and Layer-1 smart contracts (52, 54, 56) to: Enable real-time service registration and pricing updates; facilitate automated escrow verification; ensure that service conditions are met before releasing funds; enable secure transfer of assets between different blockchain layers while maintaining value consistency during cross-chain operations; and support efficient off-chain authentication, leveraging DHT (111) for identity resolution and fraud prevention.

In some embodiments, alternative or complementary data structures (e.g., Merkle trees, cryptographic accumulators, or zero-knowledge proofs) may be integrated to further enhance security, privacy, and efficiency while preserving decentralized service discovery.

By utilizing a DHT-based service registry 12, the invention generally provides a scalable, trustless, and real-time approach to managing identity verification, service availability, and pricing. This can substantially reduce centralized bottlenecks, enhance network resilience, and ensure autonomous, efficient, and secure IoT and M2M transactions.

It will be appreciated that certain transactions may require additional processes, such as transferring assets between blockchains or temporarily holding funds under predefined conditions. These processes are managed by specialized smart contract mechanisms that ensure transaction efficient execution and verifiable completion.

The system can be customized to enable automated execution of agreements within a decentralized transaction framework. Key smart contract mechanisms used in such embodiments include, but are not limited to: “Bridge Contracts”, “Escrow Contracts”, and “Verification Layers”.

“Bridge Contracts” enable movement of assets across different blockchain environments while maintaining value consistency. These contracts hold assets in one system while issuing an equivalent in another until the transaction completes.

“Escrow Contracts” temporarily hold assets or funds until predefined conditions are met, ensuring parties fulfill r obligations before final settlement.

“Verification Layers” ensure transaction completion by validating fulfillment criteria, such as service delivery or asset transfer confirmation, before releasing escrowed assets.

In their implementation and usage, smart contracts can be generalized as having two distinct functional stages: “Creation” and “Execution”. At the “Creation” stage, smart contracts are generated based on agreed conditions and deployed to the transaction network. And, at the “Execution” stage, smart contracts—once triggered by an initiating event—can be used to verify conditions, interact with other contract mechanisms, and complete transactions autonomously.

The implementation and incorporation of smart contract functionality within the invention is plentiful. For example, to promote automated payments, smart devices (and thus the users thereof) can engage in transactions where payments execute only upon confirmed service delivery. Likewise, to promote asset exchange across systems, digital assets can through smart contracts be transferred securely between separate blockchain networks while maintaining transactional integrity. Likewise, to promote conditional service agreements, funds can be held in escrow until independent verification (via smart contract processing) confirms that a service was successfully provided. These and other uses of smart contracts will be appreciated by those skilled in the art in light of the present disclosure. As shown in FIG. 1, the inventive systems includes both a Layer-2 blockchain system 300 and a Layer-1 blockchain system 200-A, B, C, D. The variable form, technology, components, capabilities, sources, providers, and behavior of the Layer-1 and Layer-2 blockchain systems are well understood and widely documented.

In a preferred embodiment, the Layer-1 blockchain system 200 is implemented using the Ethereum blockchain, leveraging its widely decentralized peer-to-peer network, robust security model, and smart contract execution capabilities. Ethereum's established framework ensures transaction immutability, transparent auditing, and secure settlement for pecuniary transactions recorded on-chain.

Other Layer-1 blockchain platforms capable of fulfilling the necessary requirements for decentralized transaction validation, smart contract execution, and cryptographically secured consensus mechanisms may also be considered. Suitable alternatives include BNB Chain, Solana, Cardano, TRON, Avalanche, and Sui. However, Ethereum is preferred due to its established ecosystem, extensive developer support, and compatibility with Layer-2 scaling solutions that are desired for meeting certain objectives of the invention.

The Layer-2 blockchain system 300 is configured to enhance the scalability and efficiency of Layer-1 transactions by implementing a rollup-based architecture, with a preference for Arbitrum due to its established security model and compatibility with Ethereum's infrastructure.

Alternative Layer-2 solutions, such as Optimism, zkSync, or StarkNet, may be employed based on implementation specific requirements. The Layer-2 system operates by batching multiple off-chain transactions and committing a summarized cryptographic proof to the Layer-1 blockchain, reducing both transaction costs and network congestion.

As shown in FIG. 1, the Layer-2 blockchain system can comprise a dedicated server facility 300 includes a “Rollup Management Module” (RM), “Fraud Prevention Module” (FP), a “Sequencer Module” (SEQ) and an “Additional Service Module” (SVC). The technical details, parameters, and functions of these and/or like modules are well documented. See e.g., A. Gangwal et al., “A Survey of Layer-Two Blockchain Protocols”, J. Net. Comp. and Apps., Vol. 209 (January 2023), and references cited therein.

For advantageous integration with decentralized financial systems, the Layer-2 system preferably supports stablecoin denominated transactions, ensuring price stability and predictability within IoT and M2M transaction environments. Stablecoins such as USDC, DAI, or other fiat-pegged digital assets serve as the unit of account for transactions, mitigating the volatility associated with native cryptocurrencies while preserving the advantages of decentralized, trustless execution.

The combination of Ethereum-based Layer-1 security with an optimized Layer-2 transaction framework enables high frequency, low cost micropayments suitable for IoT and M2M applications. By leveraging Layer-2 rollups and stablecoin integration, the invention facilitates scalable, automated, and cost-efficient digital transactions without reliance on centralized financial intermediaries, ensuring seamless interoperability between blockchain-based smart contracts and real-world machine-driven economic interactions.

As will be appreciated, as currently implemented and available, public internet includes therein access to Layer-1 and Layer-2 blockchain services and IoT and M2M service. Any of these can be utilized—in their extant form, replicated, or improved upon—for accomplishing the expressed, implicit, and foreseeable objectives of the invention. To wit: By the present invention, currently un-orchestrated, pre-existing blockchain technologies are now orchestrated to service the autonomous and decentralized pecuniary transactional needs of hosted smart device nodes by a custom-built preconfigured device-centric blockchain service interface 100.

Those skilled in the art—in light of the teachings herein—can readily appreciate several ways of introducing or otherwise providing the various service interface functions disclosed herein into an electronic network wherein IoT and/or M2M networks are contemporaneously available and accessible together with existing layer 1 and layer 2 blockchain technologies. A particularly preferred way in this regard would be to simply have available and installable a preconfigured purpose-built service interface server (or modular server facility hardware and software components independent sold or commercially available packages and kits).

For purposes of discussion, a schematic diagram of a generic Layer-3 service interface 100 is provided in FIG. 2.

As shown therein, a Layer-3 blockchain service interface 100, suited for installation within an electronic network, generally comprises a processor 105, a storage unit 110, a port 102 with both means for sending and receiving device data 101 and means for sending and receiving blockchain data 103, and a predetermined suite of blockchain transaction programming (see e.g., security module 18, service registry 12, automated process coordination module 20, and access control module 14).

The blockchain transaction programs each comprise code and algorithms that are preferably preinstalled locally on storage unit 110, which itself is integrated, bussed, plugged or otherwise in electrical communication with motherboard 104.

Processor 105 can comprise one or more central processing units (CPUS), co-processors, neural processing units (NPUs), graphical processing units (GPUS), AI accelerators, field-programmable gate arrays (FPGAS), application-specific digital circuits (ASICs), digital signal processors (DSPS), and other well-known digital logic, semiconductor chips, and circuitry; said processor or processors being hard wired into, arrayed on, plugged into, or otherwise provided in electrical communication with motherboard 104.

The storage unit 110 can be, among other known alternatives, nonvolatile memory (see e.g., ROM, MOSFETS, NAND flash, etc.), internal disk-based drives (see e.g., hard disk drives (HDDs) and optical disk drives), or internal solid state drives (SSDs) (see e.g., SSDs with form factor 2.5, or M.2, or mSATA, or U.2).

The means for sending and receiving device data 101 is engineered to send and receive device data from smart IoT and M2M device nodes operating within said electronic network. In addition to the port 102, the means 101 will comprise the electronic circuitry, logic, and programming used to accomplish sending and receiving of data. These components need not be dedicated for this function alone, and typically will be shared among other components on the motherboard, particularly in regards to said preferably provided as one or more programming, subroutines within said blockchain transaction programming.

The means for sending and receiving blockchain data 103 is engineered to send and receive blockchain data from a Layer-2 blockchain service operating within said electronic network, wherein said Layer-2 blockchain service is (as discussed hereinbefore) capable of communicating and interoperating with a Layer-1 block chain service. The components of means 103 are of the same kinds discussed with respect to means 101.

Among the suite of blockchain transaction programs, access control module 14 serves a fundamental and central role in determining the outcome of mediated pecuniary transactions in as much as it is largely responsible for assuring the identity of participating, subscribed or otherwise authorized smart devices. Toward this end, the access control module 14 is engineered to generate and promulgate at the initiation or outset of a transaction cycle the device identification token used for authentication of the sender of said device data throughout ensuing downstream processes.

Working in concert with the access control module 14, the blockchain transaction programming can include several predefined operating parameters, subroutines, executable functions, and the like. Regardless, for the interface-specific hardware embodiments of the present invention, the programming includes the following: (a) instructions for directing communication between and interoperation of said Layer-2 blockchain service and said Layer-1 blockchain service, and (b) instructions for effecting a pecuniary transaction between said smart IoT and M2M device nodes based on (i) said communication between and interoperation of said Layer-2 blockchain service and said Layer-1 blockchain service and (ii) the absence, presence, condition, or state of said device identification token.

As shown in FIG. 2, the access control module 14 can also include, or be supplemented with, or be assisted by, or interoperate with a cryptographic acceleration module 16. Though not required in all instances, implementation of the cryptographic acceleration module 16 is expected to provide a much desired improvement to transaction efficiency and speed, and is thereby favored in preferred embodiments.

When used, the cryptographic acceleration module 16 is preferably implemented with hardware optimizations that, for example, leverage dedicated cryptographic accelerators such as neural processing units (NPUs) 107, graphics processing units (GPUS) 106, application-specific integrated circuits (ASICs) 109, and field-programmable gate arrays (FPGAs) 108 that work in concert with known hardware security modules (HSMS) and Layer-3 blockchain-based decentralized identifiers (DIDs).

Unlike software-based authentication mechanisms, which depend on centralized identity providers or pre-defined public key infrastructures (PKIs), the use in preferred embodiments of low power, embedded cryptographic authentication nodes (as shown in FIG. 2) enables performance of real time zero-knowledge succinct non-interactive argument of knowledge (zk-SNARK) proof validation (and/or other ZKPs) and AI driven identity fraud detection. These hardware integrated verification nodes significantly reduce authentication latency, enabling IoT devices to securely initiate transactions with minimal computational overhead.

With or without discrete supplemental modules, the access control module 14 can itself be engineered to serve as a cryptographic security system within the Layer-3 blockchain service interface, ensuring that IoT and M2M devices are uniquely identifiable and securely authenticated before engaging in transactions. Unlike conventional authentication mechanisms, this module can be engineered to employ a hybrid multi-tier authentication model, enabling low-latency authentication at the edge layer while maintaining final verification through the blockchain network.

The authentication process carried out by the access control module 14, in general, begins with the generation of decentralized identifiers (DIDs), which are cryptographically verifiable self-sovereign identity credentials. Utilization eliminates or otherwise substantially reduces undue reliance on centralized certification authorities that are prone to bottlenecks and congestion. Furthermore, the identifiers generated can be and are preferably recorded within a sharded “distributed hash table” (DHT) 111, considerably improving retrieval speed and scalability.

If needed or desired, a challenge-response mechanism can be implemented to ensure that each participating IoT/M2M device cryptographically signs authentication requests using ephemeral key-pair rotation, and thereby mitigating so-called “replay attacks”. Authentication requests—along these lines—can be validated against local identity caches, allowing for lower latency authorization while maintaining substantially synchronized blockchain based verification. In high security applications, the access control module 14 preferably integrates zk-SNARK based verification, substantially ensuring that authentication occurs in a fraud resistant manner with lower computational overhead.

For further efficiency enhancement, the access control module 14 can also be engineered to deploy AI driven identity prediction models, which assess historical transaction behaviors and dynamically adjust authentication confidence levels. This enables preemptive validation of high likelihood authentication requests, reducing unnecessary computational delays.

The access control module 14 is in preferred embodiments engineered to interact with the service registry 12 to verify whether an authenticated smart device is authorized for a specific service, whilst concurrently the security module 18 is engineered to ensure that only verified smart devices as such are permitted to execute transactions. For an even broader range of security customization, the adaptive process coordination module 20 can also be programmed to determine whether authentication occurs on-device, at an edge node, or via a centralized blockchain ledger, more precisely targeting efficiency hot spots in larger scale IoT/M2M deployments.

In certain embodiments, the access control module 14—in a manner similar to embodiments incorporating a discrete cryptographic acceleration module 16—can be implemented utilizing dedicated NPUs, GPUs and/or ASIC accelerators, performing real time elliptic curve cryptographic operations to enhance processing speed. Alternatively, FPGA-based authentication processors can be employed to dynamically allocate cryptographic workloads based on network congestion. For IoT/M2M applications with lesser anticipated transactional burdens, the access control module 14 can be engineered to function as an energy efficient authentication microcontroller that ensures cryptographic security without excessive power consumption.

Attention is now directed to the service registry 12 of the Layer-3 service interface 100.

The service registry 12 is the decentralized system responsible for service discovery, permission verification, and price management within the Layer-3 blockchain service interface. In contrast to static registries that could also be deployed, the service registry 12—among other automated, real time, and/or dynamic functionalities—preferably integrates market driven AI-based adaptive pricing, enabling autonomous service cost adjustments based on supply-demand fluctuations, blockchain congestion, and network resource availability.

For embodiments wherein high-frequency, low-value IoT micropayments are anticipated, the service registry 12 is engineered to provide or otherwise enable AI-augmented pricing and authentication. Along these lines, the service registry 12 can be customized to employ a sharded Distributed Kash Table (DHT) architecture. In contrast to conventional blockchain-based registries that are reliant on static databases or protracted “block finality” updates, the incorporation and utilization of DHTs can enable or otherwise promote service discovery, pricing adjustments, and permission validation at a lower latency and in substantially real time. The DHT structure can also be designed to dynamically distribute service metadata, pricing history, and authentication credentials across decentralized nodes, allowing for substantially efficient, tamper resistant, and decentralized lookups without undue reliance on a single point of failure.

In certain embodiments, the service registry 12 is programmed to manage pricing and authentication using a hybrid AI-DHT model, wherein DHT indexing provides fast decentralized metadata access, while AI-driven algorithms analyze historical IoT transaction data, blockchain congestion metrics, and projected execution costs to recalibrate service fees dynamically. Unlike so-called “DeFi” pricing oracles reliant on centralized or semi-centralized pricing feeds, the combination of DHT-backed real time service indexing with predictive pricing algorithms promotes early engagement in cost optimization among participating IoT/M2M devices even before blockchain settlement occurs.

By uniquely integrating DHT-based service indexing, AI-driven predictive pricing, and decentralized Layer-3 authentication, the service registry 12 enables real-time interactions between IoT/M2M devices, smart contracts, and Layer-3 execution nodes. This eliminates latency concerns typically found in Layer-1 and Layer-2 registries by ensuring instantaneous availability of service metadata and authentication records via DHT query resolution.

To maintain service integrity, the service registry 12 cross-references device permissions stored within the access control module 14, ensuring that only authorized devices can engage with registered services. It further integrates with the security module 18, preventing unauthorized service queries by detecting anomalous access patterns. The adaptive process coordination module 20 processes service queries and determines whether execution occurs on Layer-2 rollups, within the Layer-3 framework, or through off-chain processing.

In one implementation, the service registry 12 operates on blockchain node storage, ensuring tamper proof integrity across distributed nodes. A hybrid local cloud service registry may be used in latency sensitive environments, where frequently accessed service entries are cached on edge devices to minimize lookup delays. Alternatively, a peer-to-peer marketplace architecture can be implemented, where IoT/M2M smart devices directly negotiate service terms based on real time pricing models.

Attention is now directed to the adaptive process coordination module (APCM) 20 of the Layer-3 service interface 100.

In preferred embodiments of service interface 100, the adaptive process coordination module 20 utilizes an advanced transaction execution model that combines AI-based network state prediction, dynamic rollup selection, and smart contract-driven fee reallocation, whereby blockchain settlements are procedurally optimized, substantially improved, and/or otherwise adjusted in respect of throughput, efficiency, and reliability. In contrast to Layer-2 scaling solutions that focus exclusively on batch-based rollup processing, settlement pathways mediated by the APCM 20 can be preemptively adjusted based on, for example, evolving network congestion, switching dynamically between zk-Rollups, optimistic rollups, and hybrid Layer-3 sidechain verification in real time. This continuous transaction flow adaptation represents a significant advancement over existing methods, which rely on predefined rollup aggregation structures that do not dynamically adjust to fluctuating cost and latency constraints.

To facilitate these adjustments, the adaptive process coordination module 20 is preferably implemented using dedicated cryptographic processing units, including central processing units (CPUS), neural processing units (NPUS), graphics processing units (GPUS), field-programmable gate arrays (FPGAS), and application-specific integrated circuit (ASIC) acceleration chips.

These hardware-optimized execution engines can be designed and integrated to dynamically allocate computational resources for zk-Rollup proof generation, transaction compression, and parallelized cryptographic validation. Unlike software based rollup mechanisms, which rely on fixed block-size aggregation, the preferred approach is to dynamically adjust rollup batch sizes and prioritization thresholds using AI powered predictive execution modeling, better ensuring that transactions are routed through more cost efficient paths based on real-time blockchain conditions.

The adaptive process coordination module 20 preferably integrates a distributed fault-tolerance framework, leveraging sharded Distributed Hash Table (DHT) indexing for transaction storage and execution checkpoints. This allows the system to cache previous settlement pathways, transaction fee structures, and blockchain congestion analytics, enabling historical pattern recognition to optimize or otherwise improve future transaction processing. Unlike existing Layer-2 frameworks, which rely on linear transaction sequencing models, this approach encourages adaptive batch prioritization and workload distribution, better ensuring that IoT/M2M transactions self-optimize based, for example, on historical settlement efficiency metrics.

The adaptive process coordination module 20 preferably integrates a real-time AI-driven transaction routing engine, wherein historical congestion data, live service registry updates, and predictive execution analytics are used to dynamically reallocate transaction processing between Layer-2 rollups and Layer-3 execution nodes. By further leveraging hardware accelerated cryptographic proof generation along these lines-such as field programmable gate array (FPGA)-assisted, graphics processing unit (GPU)-accelerated, neural processing unit (NPU)-optimized, or application-specific integrated circuit (ASIC)-based zk-Rollup compression engines—execution delays can be substantially reduced, better ensuring that IoT micropayments achieve near instantaneous finality while preserving blockchain integrity.

These hardware-enhanced execution models enable a new class of Layer-3 decentralized micropayment settlements, ensuring that transactions are routed, batched, and finalized in an AI-assisted, self-optimizing manner that outperforms traditional Layer-2 aggregation methods.

By utilizing a Layer-3 service interface 100, pecuniary transactions among participating IOT/M2M devices can and are preferably initially processed asynchronously using an off-chain simulation engine, providing thereby an opportunity for a service interface mediated system to preselect an optimal execution method before committing resources and time towards finalization on a blockchain. Seizing upon this opportunity, the APCM module 20 is preferably programmed to dynamically preselect, for example, between zk-Rollup aggregation, optimistic rollup processing, or direct Layer-3 execution, based on a cost-performance ratio that factors in gas fees, blockchain congestion, and execution latency.

The adaptive process coordination module 20 is programmed to communicate with and interoperate with other programmed modules of the Layer-3 service interface 100. For example, it interfaces with the service registry 12, selecting the most efficient service execution plan based on current network conditions. It also collaborates with the access control module 14 to ensure that transactions are only processed for verified devices. And, it also integrates with the security module 18 to detect fraudulent batching attempts, preventing malicious transaction aggregation. Other like collaborative processes and functions will be apparent to those skilled in the art in light of the present disclosure.

In certain embodiments, the adaptive process coordination module 20 utilizes ASIC-based acceleration to enable rapid batch processing and zk-SNARK proof generation for rollup transactions. Similarly, FPGA-based implementations can provide dynamic workload distribution, thereby promoting substantially processing efficiency. In edge-driven environments, an FPGA-based approach can also be used in support of localized transaction processing nodes that handle pre-aggregation tasks, substantially reducing computational strain on the main Layer-3 network.

Attention is now directed to security features of the Layer-3 service interface 100.

In particular, the Layer-3 blockchain service interface introduces in certain embodiments a federated learning-based fraud prevention mechanism that enhances security at a structural level beyond Layer-2 rollups.

In contrast to fraud prevention systems that rely solely on static cryptographic proof verification, the security module 18 in these embodiments integrates one or more of the following: AI-driven behavioral anomaly detection, decentralized fraud intelligence sharing, and adaptive transaction authorization mechanisms within a fully Layer-3 native service framework. These collectively enable IoT and M2M devices to collaboratively share anonymous fraud detection patterns in a privacy preserving manner, advancing real-time fraud prevention without unduly requiring centralized threat intelligence databases or predefined fraud signatures.

This approach represents a significant advancement over existing zk-Rollup based security frameworks, which traditionally focus only on batch compression of cryptographic proofs without adaptive threat detection.

In preferred embodiments, the service interface 100, largely through its security module 18, can be customized to dynamically adjust multi-signature verification thresholds based on detected fraud trends, better ensuring that high-risk transactions undergo additional verification layers before execution. By embedding these security controls directly within the Layer-3 service registry and transaction execution pipeline, the system proactively neutralizes emerging fraudulent transaction behaviors rather than passively verifying pre-set cryptographic proofs, thereby enabling a scalable, self-adaptive, and trustless security architecture for decentralized micropayments.

Instead of relying on static security policies, the security module 18 is preferably programmed to implement real-time behavioral anomaly detection, dynamically adjusting fraud detection thresholds based on transaction volume, device history, and network-wide security alerts. The system preferably detects fraudulent transactions using multi-signature authentication, where high-value payments require multiple cryptographic confirmations before execution.

When a suspicious transaction is identified, the security module 18 is preferably programmed to temporarily halt execution and query neighboring IoT/M2M devices to determine if similar fraud attempts have occurred. If a fraud signature is verified, the transaction is escalated for additional verification or routed through an escrow-based validation process, where funds remain locked until authentication is confirmed.

The security module 18 is programmed to communicate with and interoperate with other programmed modules of the Layer-3 service interface 100. The security module 18, for example, can be programmed to directly interact with the access control module 14 to better ensure that transaction initiators undergo cryptographic verification before being allowed to execute payments. It is also preferably programmed to interface with the service registry 12 to prevent unauthorized access to registered service offerings. And, it is also preferably programmed to interface with the adaptive process coordination module 20 to reprioritize transactions flagged as high-risk, thereby better ensuring that security-critical transactions undergo additional validation processes before execution. Other like collaborative processes and functions will be apparent to those skilled in the art in light of the present disclosure.

To ensure high-speed cryptographic security, the security module can be implemented using dedicated hardware security modules (HSMs) such as GPUS, NPUS, ASICS (including ASIC-based cryptographic co-processors), or FPGAS, providing secure enclave processing for transaction validation. Alternatively, AI-powered security edge nodes can handle distributed fraud detection, autonomously monitoring device behavior and blocking suspicious activities in real-time. For quantum-resilient security, the system can incorporate post-quantum cryptographic accelerators, ensuring long-term resistance against emerging quantum-based attacks.

While only a single physical server is shown in FIG. 2, embodiment utilizing two or more servers are contemplated. In these embodiments the functional duties accomplished in the single server are divided among multiple servers, and perhaps at multiple locations. Despite separation and multiplicity the deployment will be coordinated to provide singularity. Such implementation is preferred for global, national or otherwise enterprise scale deployments.

In enterprise scale deployments, additional functions and routines—supported through existing or ancillary hardware and/or software deployments—are contemplated, including redundancy systems, bandwidth and power efficiency regulators and sensors, backup systems, enterprise-scale storage systems, load balancers, administrative applications, etc.

Aside from the code governing operation of the service interface 100, the participating device contain code nodes themselves may enabling, facilitating, or otherwise influencing communication and compatibility with the service interface 100. Such code can be preinstalled by the manufacturer or downloaded or installed by customers and/or other end-users, for example through an enrollment, subscription, or registration service. APIs, device drivers, extensions, apps (such as useful for smart phones and smart watches), eproms, e2proms, and RFIDS—among other known alternatives—can be used for hosting, containing, or supporting such code.

The present invention will now be described in further detail by the following non-limiting examples of several preferred embodiments. In the examples, while each system is focused upon IoT-type smart device nodes, M2M-type smart device nodes can be similarly accommodated by those skilled in the art in light of the teachings herein. Further, in each example, the access control module, service registry, adaptive process coordination module, and security module can be implemented using hardware-accelerated cryptographic processors. These processors may include application-specific integrated circuits (ASICS), field-programmable gate arrays (FPGAS), graphics processing units (GPUS), neural processing units (NPUS), or dedicated cryptographic microcontrollers. Such implementations can enable higher-speed transaction processing and improved energy efficiency.

### Example 1

An electronic system, according to the present invention, is configured based on the system architecture specified below:

| Components | Specification |
|---|---|
| Participating Smart Device | IOT-Type |
| Nodes | |
| Layer-1 Blockchain System | Ethereum |
| Layer-2 Blockchain System | Arbitrum |
| | Stablecoin-Compatible |
| | SmartContract-Enabled |
| Layer-3 Blockchain Service | Server-Based |
| Interface | Stablecoin-Compatible |
| | SmartContract-Enabled |
| System Registry | Real-Time |
| | Price Oracle Access |
| Adaptive Process Coordination | Standard |
| Module (APCM) | |
| Access Control Module | Multi-tier |
| | Authentication |
| Security Module | Standard |

Notes:
“Standard” indicates latitude in discretionary selection and/or configuration of a component according to parameters taught hereinabove, and pursuant to prevailing commercial and technical objectives and/or factors.

In the electronic system above, the access control module is configured to support “multi-tier authentication”, which involves the caching of edge-based authentication results of participating smart device nodes, followed by a cryptographic proof (using zk-SNARKS technology) before finalizing a transaction authorization on a Layer-1 blockchain. This embodiment provides improved authentication efficiency, while maintaining process stability and scalability.

### Example 2

An electronic system, according to the present invention, is configured based on the system architecture specified below:

| Component | Specification |
|---|---|
| Participating Smart Device | IOT-Type |
| Nodes | |
| Layer-1 Blockchain System | Ethereum |
| Layer-2 Blockchain System | Arbitrum |
| | Stablecoin-Compatible |
| | SmartContract-Enabled |
| Layer-3 Blockchain Service | Server-Based |
| Interface | Stablecoin-Compatible |
| | SmartContract-Enabled |
| System Registry | Real-Time |
| | Dynamic AI Pricing |
| | Engine |
| Adaptive Process Coordination | Standard |
| Module (APCM) | |
| Access Control Module | Multi-Tier |
| | Authentication |
| Security Module | Standard |

Notes:
“Standard” indicates latitude in discretionary selection and/or configuration of a component according to parameters taught hereinabove, and pursuant to prevailing commercial and technical objectives and/or factors.

The electronic system above varies from that of Example 1 in its use at the System Registry Module of an “AI-Driven Dynamic Pricing Engine”. Details of such engines are well documented in the patent and technical literature. See e.g., U.S. Pat. App. Pub. No. 2020/0167869, published on May 28, 2020, entitled “Real-Time Predictive Analytics Engine”. In this example, the pricing engine utilizes historical transaction data, blockchain congestion metrics, and fiat-to-crypto exchange rates to compute real-time service fees, dynamically adjusting rates based on predicted market conditions. This embodiment provides results in line with Example 1, but with improved real-time price processing.

### Example 3

An electronic system, according to the present invention, is configured based on the system architecture specified below:

| Component | Specification |
|---|---|
| Participating Smart Device | IOT-Type |
| Nodes | |
| Layer-1 Blockchain System | Ethereum |
| Layer-2 Blockchain System | Arbitrum |
| | Stablecoin-Compatible |
| | SmartContract-Enabled |
| Layer-3 Blockchain Service | Server-Based |
| Interface | Stablecoin-Compatible |
| | SmartContract-Enabled |
| System Registry | Real-Time |
| | Dynamic AI Pricing |
| | Engine |
| Adaptive Process Coordination | AI-Driven Txn. Routing |
| Module (APCM) | |
| Access Control Module | Multi-tier |
| | Authentication |
| Security Module | Standard |

Notes:
“Standard” indicates latitude in discretionary selection and/or configuration of a component according to parameters taught hereinabove, and pursuant to prevailing commercial and technical objectives and/or factors.

The electronic system above varies from that of Example 2 in its use at the Adaptive Process Coordination Module of an “AI-Driven Transaction Routing Engine”. In this example, the routing engine continuously monitors historical blockchain congestion patterns, gas fee fluctuations, and service demand trends to determine whether transactions should be processed using zk-Rollups, optimistic rollups, or direct Layer-3 execution. This embodiment provides results in line with Example 2, but with improved processing costs and reduced execution latency.

### Example 4

An electronic system, according to the present invention, is configured based on the system architecture specified below:

| Components | Specification |
|---|---|
| Participating Smart Device | IOT-Type Network |
| Nodes | |
| Layer-1 Blockchain System | Ethereum |
| Layer-2 Blockchain System | Arbitrum |
| | Stablecoin-Compatible |
| | SmartContract-Enabled |
| Layer-3 Blockchain Service | Server-Based |
| Interface | Stablecoin-Compatible |
| | SmartContract-Enabled |
| System Registry | Real-Time |
| | Dynamic AI Pricing Engine |
| Adaptive Process Coordination | AI-Driven Txn. Routing |
| Module (APCM) | |
| Access Control Module | Multi-tier Authentication |
| Security Module | Anomaly Detection |

The electronic system above varies from that of Example 3 in its use at the Security Module of a “Decentralized Anomaly Detection Framework”. In this example, the anomaly detection framework utilizes federated learning techniques to enable IoT and M2M devices to collaboratively detect fraudulent transaction patterns without exposing sensitive data, and wherein detected anomalies trigger multi-signature verification mechanisms before executing predetermined high-value transactions. This embodiment provides results in line with Example 3, but with improved security.

Although certain embodiments of the invention are disclosed, those skilled in the art, having the benefit of the teaching of the present invention set forth hereinabove, can afford numerous modifications thereto. These modifications are to be construed as encompassed within the scope of the present invention as forth in the appended claims.

1. An electronic system structured to effect a pecuniary transaction between at least two device nodes within an IoT or M2M network, the electronic system comprising a Layer-1 blockchain system, a Layer-2 blockchain system, said two device nodes, and a Layer-3 blockchain service interface, wherein:
said Layer-1 blockchain system is engineered to maintain a record of transaction valuation data;
said Layer-2 system is blockchain engineered to electronically interoperate with said Layer-1 block chain system and thereby add functionality to said Layer-1 blockchain system;
said Layer-3 blockchain service interface is engineered to facilitate authentication of said device nodes utilizing decentralized identifiers associated with each authenticated device node, and to receive and execute instructions from said device nodes, and pursuant to said instructions, to electronically interoperate with said Layer-2 blockchain system, and indirectly thereby, said Layer-1 blockchain system;
whereby said pecuniary transaction between said two device nodes is effected within the electronic system by said decentralized identifiers and by electronic interoperation between (a) said Layer-3 blockchain service interface and said Layer-2 blockchain system and (b) said Layer-2 blockchain system and said Layer-1 blockchain system.

2. The electronic system of claim 1, wherein the Layer-3 blockchain service interface is provided with a service registry, said service registry electronically capable of communicating and interoperating with at least one internet-accessible pricing guide or AI-driven pricing oracle to thereby set a price and a service fee associated with said pecuniary transaction.

3. The electronic system of claim 2, wherein the service registry provides for service lookup and pricing metadata, and further comprises a distributed hash table that stores hashed device identifiers, dynamic price-offer data, and references to cryptographic proof records.

4. The electronic system of claim 2, wherein said internet-accessible pricing guide is a market-driven pricing guide programmed to autonomously formulate dynamic price and fee models based on an analysis of autonomously collected smart contract data and supply demand ratio data.

5. The electronic system of claim 2, wherein the Layer-3 blockchain service interface includes an adaptive process coordination module, the adaptive process coordination module comprising a predictive routing engine for aggregating pecuniary transaction data from said device nodes into batched transaction sets, and for analyzing real-time blockchain congestion metrics, historical gas fee data, and dynamic pricing signals to route a further processing of said pecuniary transactions either indirectly on the Layer-2 blockchain system or directly on the Layer-1 blockchain system.

6. The electronic system of claim 5, wherein the Layer-3 blockchain interface further includes a security module and an access control module, and wherein:
said security module comprises code and algorithms for communicating and interoperating with said service registry and said access control module; and
said access control module comprises code and algorithms for said facilitating of said authentication of said device nodes.

7. The electronic system of claim 6, wherein the access control module includes a hardware-based cryptographic accelerator to facilitate generation and verification of zero-knowledge proofs with reduced latency.

8. The electronic system of claim 7, wherein the access control module is configured to support a multi-tier authentication process wherein authentication of said nodes involves an edge-based authentication cache and a cryptographic proof validation using zk-SNARKS.

9. The electronic system of claim 8, wherein the security module employs a decentralized anomaly detection framework, said framework utilizing federated learning techniques to enable IoT and M2M devices to collaboratively detect fraudulent transaction patterns without exposing sensitive data, and wherein detected anomalies trigger multi-signature verification mechanisms before executing predetermined high-value transactions.

10. A method for effecting a pecuniary transaction between a first device node and a second device node within an electronic network with both Layer-1 and Layer-2 blockchain services, the transaction being executed in exchange for access to a digital service or data resource provided by the second device node, the method comprising the steps of:
providing a Layer-3 blockchain service interface within said electronic network, the service interface provided with blockchain transmission programming and being engineered to facilitate system-wide authentication of said device nodes utilizing decentralized identifiers;
receiving purchase instruction data transmitted from said first device node at said Layer-3 blockchain service interface;
processing at said Layer-3 blockchain service interface pursuant to said blockchain transmission programming the received purchase instruction data, and thereby (a) generate a device identifier referencing said first device node downstream and (b) generate and transmit a blockchain service instruction to the Layer-2 blockchain service to interoperate with the Layer-1 blockchain service and to transmit back sale instruction data, said sale instruction data being the result of both the interoperation of said Layer-2 and Layer-1 blockchain services and said device identifier;
receiving and processing the sale instruction data at said Layer-3 blockchain service interface and thereafter communicating to both the first device node and the second device node a result of said processing.

11. The method of claim 10, wherein said blockchain transmission programming includes:
a routine for interoperating with an internet-accessible price guide or AI-driven pricing oracle, and
a routine for performing zero-knowledge proof validation.

12. The method of claim 10, wherein the Layer-3 block chain service interface comprises:
(a) a service registry;
(b) an adaptive process coordination module; and
(c) a security module.

13. The method of claim 12, wherein the Layer-3 blockchain service interface provides a dedicated Layer-3 sidechain, wherein said sidechain is a result of an authentication process, an escrow management process, and a fraud prevention process.

14. A Layer-3 blockchain service interface, suited for installation within an electronic network, comprising a processor, an access control module, a port with both means for sending and receiving device data and means for sending and receiving blockchain data, and blockchain transaction programming, wherein:
said means for sending and receiving device data being engineered to send and receive device data from smart IoT and M2M device nodes operating within said electronic network;
said means sending and receiving for blockchain data being engineered to send and receive blockchain data from a Layer-2 blockchain service operating within said electronic network, wherein said Layer-2 blockchain service is capable of communicating and interoperating with a Layer-1 block chain service;
said access control module being engineered to generate a device identification token useful for downstream authentication of the sender of said device data;
said blockchain transaction programming including (a) instructions for directing communication between and interoperation of said Layer-2 blockchain service and said Layer-1 for blockchain service, and (b) instructions for effecting a pecuniary transaction between said smart IoT and M2M device nodes based on (i) said communication between and interoperation of said Layer-2 blockchain service and said Layer-1 blockchain service and (iii) said device identification token.

15. The Layer-3 blockchain service interface of claim 14, wherein said access control module employs a hardware-accelerated zero-knowledge proof algorithm to validate said device identification token.

16. The Layer-3 blockchain service interface of claim 15, wherein the Layer-3 blockchain service interface further comprises an adaptive process coordination module for selectively effecting said pecuniary transaction substantially in real time based on network load conditions.

17. The Layer-3 blockchain service interface of claim 14, further comprising a service registry, said service registry electronically capable of communicating and interoperating with at least one internet-accessible pricing guide or AI-driven pricing oracle.
